(19) United States
(12) Patent Application Publication
(10) Pub. No.: US 2010/0280169 A1
(43) Pub. Date: Nov. 4, 2010

(54) AMPHOLYTIC COPOLYMER WITH CONTROLLED ARCHITECTURE

(76) Inventor: Mathias Destarac, Montpellier (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/742,058

(22) PCT Filed: Oct. 21, 2008
(86) PCT No.: PCT/EP2008/064164

§ 371 Date: Jul. 15, 2010

(30) Foreign Application Priority Data
Nov. 9, 2007 (FR) 07 07871

(51) Int. Cl. C08L 33/26; C08G 69/26; C08F 220/60; C08L 67/00

(52) U.S. Cl. 524/555; 528/332; 526/307; 524/606

(57) ABSTRACT

The invention relates to novel ampholytic copolymers having a controlled architecture. These copolymers can particularly be used in aqueous compositions.

A subject matter of the present invention is novel ampholytic copolymers exhibiting a controlled architecture. These copolymers can in particular be used in aqueous compositions.

The document [Lowe et al., Chem. Rev., 2002, 102, 4177] describes block copolymers comprising a block deriving from monomers comprising a tertiary amine group and a block deriving from monomers comprising a carboxyl group. This document also mentions the documents [Beturov et al., J. Makromol. Chem., 1990, 191, 457] and [Beturov et al., J. Makromol. Chem., Rapid Commun., 1992, 13, 225] as describing block copolymers comprising a block deriving from 1-methyl-4-vinylpyridinium chloride and a block deriving from methacrylic acid.

The document [Lowe et al., Macromolecules, 1998, 31, 5991] also describes block copolymers comprising a block deriving from monomers comprising a tertiary amine group and a block deriving from methacrylic acid. The process employs a group transfer polymerization and implies protection and then deprotection of the methacrylic acid.

The document [Vo et al., Macromolecules, 2007, 40, 157; Cai et al., Macromolecules, 2005, 36, 271] describes block copolymers comprising a block deriving from monomers comprising a tertiary amine group and a block deriving from monomers comprising a carboxyl group. The process employs a polymerization of ATRP type and a postpolymerization esterification reaction with succinic anhydride in order to obtain carboxyl groups.

The document [Gabaston et al., Polymer, 1999, 40, 4505] describes a block copolymer comprising a block deriving from VBTMAC and a block deriving from sodium styrenesulfonate. This copolymer is insoluble in water. The process employs a polymerization using nitroxides.

The document [Xin et al., Eur. Polym. J., 2005, 41, 1539; Metoglu et al., Polymer, 2005, 46, 7726] describes block copolymers comprising a block deriving from monomers comprising a tertiary amine group and a block deriving from sodium acrylate.

There exists a need for other ampholytic copolymers, in particular for copolymers which can be used in aqueous compositions. There exists in particular a need for ampholytic copolymers which can contribute novel properties to compositions comprising a stabilized product. There also exists a need for simpler processes for the preparation of ampholytic copolymers with controlled architecture.

The present invention meets at least one of the abovementioned needs by providing an ampholytic copolymer comprising at least one macromolecular chain B and at least one part A bonded to one end of the macromolecular chain B, in which:
the macromolecular chain B comprises cationic units B_{C} deriving from cationic monomers B_{C},
the part A is a macromolecular chain A comprising potentially anionic units A_{A} deriving from potentially anionic monomers A_{A}, characterized in that:
the units B_{C} comprise a quaternary ammonium group, and
the units A_{A} comprise a group chosen from the following groups, in the acid or salified form:
the carboxyl group —COO⁻
the sulfonate group —SO₃⁻
the sulfate group —SO₄⁻
the phosphonate group —PO₃²⁻
the phosphate group —PO₄²⁻,
   the units A_{A} being other than units deriving from styrenesulfonate in the acid or salified form.

The invention also relates to a process for the preparation of such copolymers, where the copolymer is a block copolymer, preferably a linear block copolymer, comprising at least one block A and at least one block B, where the macromolecular chain A constitutes the block A and the macromolecular chain B constitutes the block B,

said process comprising the following stages:
stage 1): polymerization, preferably by controlled radical polymerization, of monomers, so as to obtain a first block chosen from the block A and the block B, or a precursor block of the first block,
stage 2): polymerization, preferably by controlled radical polymerization, of monomers, so as to obtain at least one second block chosen from the block A, if a block B or a precursor was obtained in stage 1), and the block B, if a block A or a precursor was obtained in stage 1), or a precursor block of the second block, stage 3) optional: if precursor blocks were obtained during stages 1) and/or 2), chemical modification of these blocks, so as to obtain the block A and the block B.

The process of the invention is particularly simple, effective and/or economically advantageous.

The invention also relates to the use of the copolymers of the invention in compositions, for example aqueous compositions, comprising a product dispersed or dissolved in the composition. The invention also relates to compositions comprising said product and the copolymer of the invention. The compositions can in particular be compositions for the treatment and/or modification of surfaces, for example coating compositions, cosmetic compositions, compositions for caring for laundry, compositions for cleaning dishes or compositions for caring for (for example cleaning) hard surfaces. The compositions can in particular be compositions for water treatment or compositions for the construction industry and civil engineering, in particular compositions comprising a hydraulic binder. The compositions can in particular be pharmaceutical or plant-protection compositions. The invention also relates to the use of the compositions in the context for which they are intended.

### DEFINITIONS

In the present patent application, “unit deriving from a monomer” denotes a unit which can be obtained directly from said monomer by polymerization. Thus, for example, a unit deriving from an acrylic or methacrylic acid ester does not cover a unit of formula —CH₂—CH(COOH)—, or —CH₂—C(CH₃)(COOH)—, for example obtained by polymerizing an acrylic or methacrylic acid ester and then by hydrolyzing. Thus, the terminology “unit deriving from a monomer” relates only to the final composition of the polymer and is independent of the polymerization process used to synthesize the polymer.

In the present patent application, the term “hydrophobic”, for a monomer, is used in its normal sense of “which does not have an affinity for water”; this means that the monomer can form a two-phase macroscopic solution in distilled water at 25° C., at a concentration of greater than or equal to 1% by weight, or has been categorized as hydrophobic in the present patent application.

In the present patent application, the term “hydrophilic”, for a monomer, is also used in its normal sense of “which has an affinity for water”, that is to say is not capable of forming a two-phase macroscopic solution in distilled water at 25° C., at a concentration of greater than or equal to 1% by weight, or has been categorized as hydrophilic in the present patent application.

Anionic or potentially anionic units is understood to mean units which comprise an anionic or potentially anionic group and/or which have been categorized as such. Anionic units or groups are units or groups which exhibit at least one negative charge (generally in combination with one or more cations, such as cations of alkali metal or alkaline earth metal compounds, for example sodium, or with one or more cationic compounds, such as ammonium), whatever the pH of the medium in which the copolymer is present. Potentially anionic units or groups are units or groups which can be neutral or can exhibit at least one negative charge, depending on the pH of the medium in which the copolymer is present. In this case, potentially anionic units in the neutral form or in the anionic form will be referred to. By extension, anionic or potentially anionic monomers can be referred to. Groups regarded as anionic are typically strong acid groups, for example with a pKa of less than or equal to 2. Groups regarded as potentially anionic are typically weak acid groups, for example with a pKa of greater than 2.

Cationic or potentially cationic units is understood to mean units which comprise a cationic or potentially cationic group and/or which have been categorized as such. Cationic units or groups are units or groups which exhibit at least one positive charge (generally in combination with one or more anions, such as the chloride ion, the bromide ion, a sulfate group or a methyl sulfate group), whatever the pH of the medium into which the copolymer is introduced. Potentially cationic units or groups are units or groups which can be neutral or can exhibit at least one positive charge, depending on the pH of the medium into which the copolymer is introduced. In this case, potentially cationic units in the neutral form or in the cationic form will be referred to. By extension, cationic or potentially catonic monomers can be referred to.

Neutral units is understood to mean units which do not exhibit a charge, whatever the pH of the medium in which the copolymer is present.

In the present patent application, the ratio by weight between blocks corresponds to the ratio between the weights of the monomers (or mixtures of monomers) used for the preparation of the blocks (taking into account the variations in weights related to a possible subsequent modification). The proportions by weight of the blocks are the proportions with respect to the total block copolymer and correspond to the proportions by weight of the monomers (or the mixtures of monomers) used for the preparation of the blocks, with respect to the whole of the monomers used to prepare the block copolymer (taking into account the variations in weights related to possible subsequent modification).

In the present patent application, the term transfer agent is understood to mean an agent capable of inducing controlled radical polymerization in the presence of unsaturated monomers and optionally of a source of free radicals.

In the present patent application, a composition formed of monomers employed during a polymerization stage is defined by the nature and the relative amount of monomers. The composition can be a single monomer. It can be a combination of several monomers (comonomers), of different natures, in given proportions. Likewise, a composition of a macromolecular chain or a composition formed of units of a macromolecular chain is defined by the nature and the relative amount of the monomers from which the units of the macromolecular chain are derived. The matter may concern a macromolecular chain deriving from a single monomer (homopolymer chain). The matter may concern a macromolecular chain having units derived from several monomers of different natures, in given proportions (copolymer chain).

In the present patent application, a different composition formed of monomers denotes a composition for which the nature of the monomer or monomers and/or for which their proportions of different monomers are different. It is the same, by analogy, for a different macromolecular chain or a different composition formed of units. A composition formed of monomers comprising 100% of a monomer M¹ is different from a composition comprising 100% of a monomer M². A composition formed of monomers comprising 50% of a monomer M¹ and 50% of a monomer A¹ is different from a composition comprising 10% of the monomer M¹ and 90% of the monomer A¹. A composition formed of monomers comprising 50% of a monomer M¹ and 50% of a monomer A¹ is different from a composition comprising 50% of the monomer M¹ and 50% of the monomer A².

In the present patent application, for simplicity, units deriving from a monomer are sometimes put into the same category as the monomer itself, and vice versa.

In the present patent application, an ethylenically unsaturated monomer is a compound comprising a polymerizable carbon-carbon double bond. It can be a monoethylenically unsaturated monomer, preferably an α-monoethylenically unsaturated monomer, or a polyethylenically unsaturated monomer. In the present patent application, for the compounds other than star copolymers and for processes other than processes for the preparation of star copolymers, an ethylenically unsaturated monomer denotes a monoethylenically unsaturated monomer, preferably an α-monoethylenically unsaturated monomer.

In the present patent application, the measured average molecular weight of a first block of a first part or of a copolymer denotes the number-average molecular weight in polyoxyethylene equivalents of a block or of a copolymer, measured by steric exclusion chromatography (SEC), with calibration using polyoxyethylene standards. The measured average molecular weight of an nth block or of a nth part in a copolymer comprising n blocks or n parts is defined as the difference between the measured average molecular weight of the copolymer and the measured average molecular weight of the copolymer comprising (n−1) blocks or parts from which it is prepared.

For the sake of simplicity, it is common to express the average molecular weights of the blocks or parts as “theoretical” or “targeted” average molecular weights, from the amounts of monomers and polymerization agents employed, taking into consideration a complete and perfectly controlled polymerization. Such calculations can be carried out conventionally. For example, one macromolecular chain can be formed per transfer functional group of a transfer agent; in order to obtain the molecular weight, it is sufficient to multiply the average molar mass of the units of a block by the number of units per block (amount by number of monomer by amount by number of transfer agent). The theoretical average molecular weight M_{block} of a block is typically calculated according to the following formula:

$${M}_{block} = {\sum }_{i} {M}_{i} * \frac{{n}_{i}}{{n}_{precursor}} ,$$

where Mᵢ is the molar mass of a monomer i, nᵢ is the number of moles of the monomer i and n_{precursor} is the number of moles of functional groups to which the macromolecular chain of the block will be bonded. The functional groups can originate from a transfer agent (or a transfer group) or an initiator, a preceding block, and the like. If a preceding block is concerned, the number of moles can be regarded as the number of moles of a compound to which the macromolecular chain of said preceding block has been bonded, for example a transfer agent (or a transfer group) or an initiator. In practice, the theoretical average molecular weights are calculated from the number of moles of monomers introduced and from the number of moles of precursor introduced.

The “theoretical” or “targeted” average molecular weight of a block copolymer is considered to be the addition of the average molecular weights of each of the blocks.

Ampholytic Copolymer

The ampholytic copolymer comprises:
at least one macromolecular chain B comprising cationic units B_{C} deriving from cationic monomers B_{C}, and
at least one macromolecular chain A bonded to a single end of at least one macromolecular chain B.

It is observed that the ampholytic copolymer can comprise only one or several part(s) B. It is observed that the ampholytic copolymer can comprise only one or several part(s) A. If the copolymer comprises several parts A, they can be bonded to different ends of the part B.

The macromolecular chain A is preferably linear (in contrast to a branched and/or star-shaped and/or crosslinked chain). The macromolecular chain B is preferably linear (in contrast to a branched and/or star-shaped and/or crosslinked chain). Advantageously, both of the macromolecular chains A and B are linear. The macromolecular chains A and B can be bonded to one another via a carbon-carbon bond or via another type of bond.

According to a specific embodiment, the copolymer exhibits one or two macromolecular chains B which are bonded to the macromolecular chain A at one or both of the ends of the latter. According to another specific embodiment, the copolymer exhibits one or two macomolecular chains A which are bonded to the macromolecular chain B at one or both of the ends of the latter.

The macromolecular chain B can be likened to a “block B” and the macromolecular chain A can be likened to a “block A”. The ampholytic copolymer can be referred to as an ampholytic “block copolymer”. Preferably, for this alternative form, the macromolecular chains A and B are bonded to one another via a carbon-carbon bond. The copolymer is preferably a block copolymer, preferably a linear block copolymer, comprising at least one block A and at least one block B, where the macromolecular chain A constitutes the block A and the macromolecular chain B constitutes the block B.

The ampholytic copolymer can in particular be chosen from the following copolymers:
(block A)-(block B) diblock copolymer, the part A constituting the block A and the macromolecular chain B constituting the block B,
(block B)-(block A)-(block B) triblock copolymer, the part A constituting the block A and the macromolecular chain B constituting the block B,
(block A)-(block B)-(block A) triblock copolymer, the part A constituting the block A and the macromolecular chain B constituting the block B.

According to a preferred embodiment, the copolymer is a linear diblock or triblock copolymer, the block A and/or the block B of which, preferably both, derives from ethylenically unsaturated monomers, preferably from mono-α-ethylenically unsaturated monomers, and/or from monomers of cyclopolymerizable diallyl type (such as N,N-dimethyldiallylammonium chloride “DADMAC”).

The units A_{A} comprise an “anionic or potentially anionic” group chosen from the following groups, in the acid or salified form:
the carboxylate group —COO⁻
the sulfonate group —SO₃⁻
the sulfate group —SO₄⁻
the phosphonate group —PO₃²⁻
the phosphate group —PO₄²⁻.

Groups regarded as anionic are typically strong acid groups, for example with a pKa of less than or equal to 2. Groups regarded as potentially anionic are typically weak acid groups, for example with a pKa of greater than 2.

The units A_{A} are different from the units deriving from styrenesulfonate in the acid or salified form. However, it is mentioned that the copolymer can comprise units deriving from styrenesulfonate (anionic units) in combination with other units as defined above. Preferably, the copolymers does not comprise units deriving from styrenesulfonate. According to a specific embodiment, the anionic or potentially anionic group is other than a sulfonate group.

If the group is in the acid form, it is combined with at least one or more protons. The group can be combined with a counterion (a cation) other than a proton. It can in particular be a cation of an alkali metal or alkaline earth metal, in particular the sodium or potassium ion, or an organic cation, for example an ammonium ion. It is observed that the cationic groups of the part B can constitute all or a portion of the counterions combined with the anionic or potentially anionic group. Mention is made that the anionic or potentially anionic groups are not zwitterionic groups comprising both a cationic group and an anionic or potentially anionic group (they would then have a zero charge overall).

The B_{C} units are cationic units. They comprise cationic groups comprising a quaternary ammonium group. In the present patent application, the cationic groups do not cover potentially cationic groups of weak base type capable of becoming cationic by addition of a proton, such as primary or secondary amines, or even such as amide groups. The cationic groups can in particular be groups of the following type:
quaternary ammonium (of formula —N⁺R₃ where R, identical or different, is a group other than the hydrogen atom, for example an optionally substituted hydrocarbon group, if appropriate interrupted by heteroatoms, for example a linear or branched C₁-C₂₂ alkyl group, for example a methyl group).

The possibility is not excluded of combining groups of quaternary ammonium type with cationic groups of the following type:
inium (of formula ═N⁺R₂ where R, identical or different, is a group other than the hydrogen atom, one of which, if appropriate, forms part of a ring connected to the double bond, said ring being, if appropriate, aromatic, it being possible for at least one of the R groups to be, for example, an optionally substituted hydrocarbon group, if appropriate interrupted by heteroatoms, for example a linear or branched C₁-C₂₂ alkyl group, for example a methyl group).

In the case of the groups of quaternary ammonium type, the group concerned may in particular be a trimethylammonium group.

In the case of the inium groups, the group concerned may in particular be a pyridinium group, preferably an alkylpyridinium group, preferably a methylpyridinium group.

The cationic group can be combined with a counterion (an anion). It can in particular be a chloride, bromide, iodide, nitrate, methyl sulfate or ethyl sulfate ion. It is observed that the anionic or potentially anionic groups of the part A can constitute all or a portion of the counterions combined with the cationic group. Mention is made that the cationic units are not zwitterionic units comprising both a cationic group and an anionic or potentially anionic group (they would then have a zero charge overall). In other words, the R groups mentioned above do not comprise an anionic substituent.

The net charge of the copolymer can in particular be positive at least a pH of greater than or equal to 4.5, preferably of greater than or equal to 7.

Mention may be made, as examples of monomers B_{C} from which the units B_{C} can be derived, of:
trimethylammoniopropyl methacrylate chloride,
trimethylammonioethylacrylamide or -methacrylamide chloride or bromide,
trimethylammoniobutylacrylamide or -methylacrylamide methyl sulfate,
trimethylammoniopropylmethacrylamide methyl sulfate (MAPTA MeS),
(3-methacrylamidopropyl)trimethylammonium chloride (MAPTAC),
(3-acrylamidopropyl)trimethylammonium chloride (APTAC),
methacryloyloxyethyltrimethylammonium chloride or methyl sulfate,
acryloyloxyethyltrimethylammonium salts (ADAMQUAT),
N,N-dimethyldiallylammonium chloride (DADMAC);
dimethylaminopropylmethacrylamide, N-(3-chloro-2-hydroxypropyl)trimethylammonium chloride (DIQUAT);
the monomer of formula:

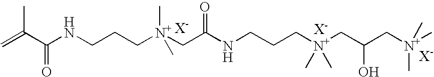

where X⁻ is an anion, preferably chloride or methyl sulfate,
their mixtures or combinations.

Mention may in particular be made, as examples of monomers from which units comprising a group of inium type can be derived, of 1-ethyl-2-vinyl-pyridinium or 1-ethyl-4-vinylpyridinium bromide, chloride or methyl sulfate.

The units B_{C} can in particular be obtained by polymerization, in order to form at least one macromolecular chain B, of monomers comprising the monomers B_{C} (if appropriate as a mixture with other monomers). They can also be obtained by polymerization, in order to form at least one precursor macromolecular chain B_{precursor}, of monomers comprising precursor monomers of units B_{C} (if appropriate as a mixture with other monomers), resulting in precursor units of the units B_{C}, followed by chemical modification of the precursor units in order to obtain the units B_{C} in a macromolecular chain B. Such modifications are known. They can, for example, be quaternizations, for example using dimethyl sulfate or quaternary haloalkylammoniums or quaternary haloalkylhydroxyalkylammoniums.

The macromolecular chain B can comprise units Bₒₜₕₑᵣ, other than the units B_{C}, not comprising a cationic group, deriving from monomers Bₒₜₕₑᵣ, other than the monomers B_{C}, not comprising a cationic group. They can in particular be:
units Nₚₕᵢₗₑ, which are neutral hydrophilic units deriving from neutral hydrophilic monomers Nₚₕᵢₗₑ,
units N_{phobe}, which are neutral hydrophobic units deriving from neutral hydrophobic monomers N_{phobe},
anionic or potentially anionic units B_{A}, deriving from anionic or potentially anionic monomers B_{A},
zwitterionic units Z, deriving from zwitterionic monomers Z,
potentially cationic units C, deriving from potentially cationic monomers,
their mixtures or combinations.

The proportion by weight of units Bₒₜₕₑᵣ in the macromolecular chain B can be from 0 to 99%, preferably from 0 to 90%, preferably from 0 to 50%, for example from 0 to 25%. It can advantageously be zero (no units Bₒₜₕₑᵣ). The macromolecular chain B preferably comprises from 1 to 100% by weight of units B_{C}, preferably from 50 to 100%.

In the case where a macromolecular chain B comprises units B_{A}, their proportion by number in said chain is preferably less than that in the macromolecular chain A, if such a chain is present. Preferably, the proportion by number of units B_{A} in a macromolecular chain B is less than the proportion by number of units B_{C}. Preferably, the proportion by number of units B_{A} in a macromolecular chain B is less than 10%, preferably zero.

Mention may be made, as examples of monomers C from which units C can be derived, of:
N,N-dimethylaminomethylacrylamide or -methacrylamide,
2-(N,N-dimethylamino)ethylacrylamide or -methacrylamide,
3-(N,N-dimethylamino)propylacrylamide or -methacrylamide,
4-(N,N-dimethylamino)butylacrylamide or -methacrylamide
2-(dimethylamino)ethyl acrylate (ADAM),
2-(dimethylamino)ethyl methacrylate (DMAM or MADAM),
3-(dimethylamino)propyl methacrylate,
2-(tert-butylamino)ethyl methacrylate,
2-(dipentylamino)ethyl methacrylate,
2-(diethylamino)ethyl methacrylate
vinylpyridines,
vinylamine,
vinylimidazolines.

Mention may be made, as examples of monomers Nₚₕᵢₗₑ from which units Nₚₕᵢₗₑ can be derived, of:
hydroxyalkyl esters of α,β-ethylenically unsaturated acids, such as hydroxyethyl or hydroxypropyl acrylates and methacrylates, glycerol monomethacrylate, and the like,
α,β-ethylenically unsaturated amides, such as acrylamide, methacrylamide, N,N-dimethylmethacrylamide, N-methylolacrylamide, and the like
α,β-ethylenically unsaturated monomers carrying a water-soluble polyoxyalkylene segment of the polyethylene oxide type, such as polyethylene oxide α-methacrylates (Bisomer S20W, S10W, and the like, from Laporte) or polyethylene oxide α,ω-dimethacrylates, Sipomer BEM from Rhodia (ω-behenyl polyoxyethylene methacrylate), Sipomer SEM-25 from Rhodia (ω-tristyrylphenyl polyoxyethylene methacrylate), and the like,
vinyl alcohol,
α,β-ethylenically unsaturated monomers which are precursors of hydrophilic units or segments, such as vinyl acetate, which, once polymerized, can be hydrolyzed to produce vinyl alcohol units or polyvinyl alcohol segments,
vinyllactams, such as vinylpyrrolidones or N-vinylcaprolactam,
α,β-ethylenically unsaturated monomers of ureido type and in particular the methacrylamido of 2-imidazolidinone ethyl (Sipomer WAM II from Rhodia),
nonethylene glycol methyl ether acrylate or nonethylene glycol methyl ether methacrylate,
their mixtures or combinations.

Mention may be made, as examples of monomers N_{phobe} from which N_{phobe} units can be derived, of:
vinylaromatic monomers, such as styrene, α-methylstyrene, vinyltoluene, and the like,
vinyl or vinylidene halides, such as vinyl chloride or vinylidene chloride, or vinylaromatic halides, such as pentafluorostyrene,
C₁-C₁₂ alkyl esters of α,β-monoethylenically unsaturated acids, such as methyl acrylate, methyl methacrylate, ethyl acrylate, ethyl methacrylate, butyl acrylate, butyl methacrylate, 2-ethylhexyl acrylate, and the like,
vinyl or allyl esters of saturated carboxylic acids, such as vinyl or allyl acetates, propionates, versatates, stearates, and the like,
α,β-monoethylenically unsaturated nitriles comprising from 3 to 12 carbon atoms, such as acrylonitrile, methacrylonitrile, and the like,
α-olefins, such as ethylene, and the like,
conjugated dienes, such as butadiene, isoprene or chloroprene,
monomers capable of generating polydimethylsiloxane chains (PDMS).
   Thus, the part B can be a silicone, for example a polydimethylsiloxane chain or a copolymer comprising dimethylsiloxy units,
diethylene glycol ethyl ether acrylate or diethylene glycol ethyl ether methacrylate,
their mixtures or combinations.

Mention may be made, as examples of zwitterionic monomers Z from which zwitterionic units Z can be derived, of:
monomers carrying a carboxybetaine group,
monomers carrying a sulfobetaine group, for example sulfopropyldimethylammonioethyl methacrylate (SPE), sulfoethyldimethyl-ammonioethyl methacrylate, sulfobutyldimethylammonioethyl methacrylate, sulfohydroxypropyldimethylammonioethyl methacrylate (SHPE), sulfopropyldimethylammoniopropylacrylamide, sulfopropyl-dimethylammoniopropylmethacrylamide (SPP), sulfohydroxypropyl-dimethylammoniopropylmethacrylamide (SHPP), sulfopropyldiethyl-ammonioethyl methacrylate or sulfohydroxypropyldiethylammonioethyl methacrylate,
monomers carrying a phosphobetaine group, such as phosphatoethyl-trimethylammonioethyl methacrylate,
their mixtures or combinations.

Mention may be made, as examples of monomers B_{A} from which units B_{A} can be derived, of the monomers A_{A} described in detail below.

The macromolecular chain A of the second embodiment comprises anionic or potentially anionic units A_{A} deriving from monomers A_{A}.

Mention may be made, as examples of monomers A_{A} from which the units A_{A} can be derived, of:
monomers having at least one carboxyl functional group, such as α,β-ethylenically unsaturated carboxylic acids or the corresponding anhydrides, such as acrylic acid, acrylic anhydride, methacrylic acid, methacrylic anhydride, maleic acid, maleic anhydride, fumaric acid, itaconic acid, N-methacryloylalanine, N-acryloylglycine, para-carboxystyrene, and their water-soluble salts,
monomers which are precursors of carboxylate functional groups, such as tert-butyl acrylate, which produce, after polymerization, carboxyl functional groups by hydrolysis,
monomers having at least one sulfate or sulfonate functional group, such as 2-sulfooxyethyl methacrylate, vinylbenzenesulfonic acid, allylsulfonic acid, 2-acrylamido-2-methylpropanesulfonic acid, sulfoethyl acrylate or methacrylate, sulfopropyl acrylate or methacrylate, and their water-soluble salts,
monomers having at least one phosphonate or phosphate functional group, such as vinylphosphonic acid, and the like, ethylenically unsaturated phosphate esters, such as phosphates derived from hydroxyethyl methacrylate (Empicryl 6835 from Rhodia) and those derived from polyoxyalkylene methacrylates, and their water-soluble salts,
their mixtures or combinations.

Mention is in particular made, as examples of monomers comprising a phosphate or phosphonate functional group, of:
N-methacrylamidomethylphosphonic acid ester derivatives, in particular the n-propyl ester (RN 31857-11-1), the methyl ester (RN 31857-12-2), the ethyl ester (RN 31857-13-3), the n-butyl ester (RN 31857-14-4) or the isopropyl ester (RN 51239-00-0), and their phosphonic monoacid and diacid derivatives, such as N-methacrylamidomethylphosphonic diacid (RN 109421-20-7),
N-methacrylamidoethylphosphonic acid ester derivatives, such as N-methacrylamidoethylphosphonic acid dimethyl ester (RN 266356-40-5) or N-methacrylamidoethylphosphonic acid di(2-butyl-3,3-dimethyl) ester (RN 266356-45-0), and their phosphonic monoacid and diacid derivatives, such as N-methacrylamidoethylphosphonic diacid (RN 80730-17-2),
N-acrylamidomethylphosphonic acid ester derivatives, such as N-acrylamidomethylphosphonic acid dimethyl ester (RN 24610-95-5), N-acrylamidomethylphosphonic acid diethyl ester (RN 24610-96-6) or bis(2-chloropropyl) N-acrylamidomethylphosphonate (RN 50283-36-8), and their phosphonic monoacid and diacid derivatives, such as N-acrylamidomethylphosphonic acid (RN 151752-38-4),
vinylbenzylphosphonate ester dialkyl derivatives, in particular the di(n-propyl) (RN 60181-26-2), di(isopropyl) (RN 159358-34-6), diethyl (RN 726-61-4), dimethyl (RN 266356-24-5), di(2-butyl-3,3-dimethyl) (RN 266356-29-0) and di(t-butyl) (RN 159358-33-5) ester derivatives, and their phosphonic monoacid and diacid alternative forms, such as vinylbenzylphosphonic diacid (RN 53459-43-1), diethyl 2-(4-vinylphenyl)ethanephosphonate (RN 61737-88-0),
dialkylphosphonoalkyl acrylate and methacrylate derivatives, such as 2-(acryloyloxy)ethylphosphonic acid dimethyl ester (RN 54731-78-1) and 2-(methacryloyloxy)ethylphosphonic acid dimethyl ester (RN 22432-83-3), 2-(methacryloyloxy)methylphosphonic acid diethyl ester (RN 60161-88-8), 2-(methacryloyloxy)methylphosphonic acid dimethyl ester (RN 63411-25-6), 2-(methacryloyloxy)propylphosphonic acid dimethyl ester (RN 252210-28-9), 2-(acryloyloxy)methylphosphonic acid diisopropyl ester (RN 51238-98-3) or 2-(acryloyloxy)ethylphosphonic acid diethyl ester (RN 20903-86-0), and their phosphonic monoacid and diacid alternative forms, such as 2-(methacryloyloxy)ethylphosphonic acid (RN 80730-17-2), 2-(methacryloyloxy)methylphosphonic acid (RN 87243-97-8), 2-(methacryloyloxy)propylphosphonic acid (RN 252210-30-3), 2-(acryloyloxy)propylphosphonic acid (RN 254103-47-4) and 2-(acryloyloxy)ethylphosphonic acid,
vinylphosphonic acid, optionally substituted by cyano, phenyl, ester or acetate groups, vinylidenephosphonic acid, in the sodium salt form or the form of its isopropyl ester, or bis(2-chloroethyl) vinyiphosphonate,
2-(methacryloyloxy)ethyl phosphate,
2-(acryloyloxy)ethyl phosphate,
2-(methacryloyloxy)propyl phosphate,
2-(acryloyloxy)propyl phosphate,
vinylphosphonic acid,
2-(methacryloyloxy)ethylphosphonic acid,
2-(acryloyloxy)ethylphosphonic acid,
2-(methacryloyloxy)ethyl phosphate, and
2-(acryloyloxy)ethyl phosphate.

The units A_{A} can in particular be obtained by polymerization, in order to form the macromolecular chain A, of monomers comprising the monomers A_{A} (if appropriate as a mixture with other monomers). They can also be obtained by polymerization, in order to form at least one precursor macromolecular chain A_{precursor}, of monomers comprising precursors monomers of units A_{A} (if appropriate as a mixture with other monomers), resulting in precursor units of the units A_{A}, followed by chemical modification of the precursor units, in order to obtain the units A_{A} in the macromolecular chain A. Such modifications are known. They can, for example, be hydrolyses of units comprising a hydrolyzable ester group (units deriving from ethyl or tert-butyl acrylate or methacrylate, for example).

The macromolecular chain A can comprise units Aₒₜₕₑᵣ, other than the units A_{A}, not comprising an anionic or potentially anionic group, deriving from monomers Aₒₜₕₑᵣ, other than the monomers A_{A}, not comprising an anionic or potentially anionic group. They can in particular be:
units Nₚₕᵢₗₑ, which are neutral hydrophilic units deriving from neutral hydrophilic monomers Nₚₕᵢₗₑ (such units and monomers are described above),
units N_{phobe}, which are neutral hydrophobic units deriving from neutral hydrophobic monomers N_{phobe} (such units and monomers are described above),
cationic units A_{C} deriving from cationic monomers A_{C},
zwitterionic units Z deriving from zwitterionic monomers Z (such units and monomers are described above),
potentially cationic units C deriving from potentially cationic monomers (such units and monomers are described above),
their mixtures or combinations.

The proportion by weight of units Aₒₜₕₑᵣ in the macromolecular chain A can be from 0 to 99%, preferably from 0 to 90%, preferably from 0 to 50%, for example from 0 to 25%. It can advantageously be zero (no units Aₒₜₕₑᵣ). The macromolecular chain A preferably comprises from 1 to 100% by weight of units A_{A}, preferably from 50 to 100%.

In the case where a macromolecular chain A comprises units A_{C}, their proportion by number in said chain is preferably less than that in the macromolecular chain B. Preferably, the proportion by number of units A_{C} in a macromolecular chain A is less than the proportion by number of units A_{A}. Preferably, the proportion by number of units A_{C} in a macromolecular chain A is less than 10%, preferably zero.

Mention may be made, as examples of monomers A_{C} from which units A_{C} can be derived, of the monomers B_{C} described in detail above.

Also by way of example, the ampholytic copolymer can be a block copolymer in which the block A derives from acrylic acid and the block B derives from a cationic monomer chosen from DADMAC, MAPTAC and APTAC.

The ampholytic copolymer preferably comprises more, by number, units B_{C} than anionic or potentially anionic units A_{A}. Preferably, it comprises more, by number, units B_{C} than units A_{A}.

Preferably, the ratio by weight of the macromolecular chain(s) B, preferably the block(s) B, to the macromolecular chain(s) A, preferably the block(s) A, is greater than 1, for example greater than 2. The ratio by weight of the macromolecular chain A to the part B can alternatively be greater than 1, preferably greater than 2.

The ampholytic copolymer can in particular exhibit a theoretical or measured average molecular weight of between 500 and 50 000 g/mol. The macromolecular chain(s) B, preferably the block(s) B can in particular exhibit a theoretical or measured average molecular weight of between 500 and 49 000 g/mol, preferably between 2 000 and 48 000 g/mol. The macromolecular chain(s) A, preferably the block(s) A, can in particular exhibit a theoretical or measured average molecular weight of between 250 and 20 000 g/mol, preferably between 500 and 10 000 g/mol.

The ampholytic copolymer is preferably water-soluble, and preferably water-soluble over the whole of the pH range extending from 5 to 8, preferably from 4 to 9, preferably from 1 to 11. The nature and the proportions of the various units can be chosen to this end. Preferably, it comprises less than 50% by weight of units N_{phobe}, preferably less than 25%, preferably less than 10%, for example not at all.

The copolymer can be provided in the solid form or in the form of a solution, for example an aqueous, alcoholic and/or aqueous/alcoholic solution (for example in an ethanol or isopropanol/water mixture). The concentration of the solution can, for example, be from 5 to 75% by weight, typically from 10 to 50% by weight.

Useful Processes for the Preparation of the Ampholytic Copolymers

The ampholytic copolymer can be prepared by any appropriate process comprising sequential polymerizations. Such processes are known. The copolymer can in particular be prepared by sequential polymerizations, preferably of controlled radical polymerization type.

Use may in particular be made of a process comprising the following stages for preparing block copolymers:

Stage 1): polymerization, preferably by controlled radical polymerization, of monomers, so as to obtain a first block chosen from the block A and the block B, or a precursor block of the first block,

Stage 2): polymerization, preferably by controlled radical polymerization, of monomers, so as to obtain at least one second block chosen from the block A, if a block B or a precursor was obtained in stage 1, and the block B, if a block A or a precursor was obtained in stage 1), or a precursor block of the second block,

Stage 3): optional: if precursor blocks were obtained during stages 1) and/or 2), chemical modification of these blocks, so as to obtain the block A and the block B.

The block B is preferably prepared by polymerization of monomers comprising cationic monomers B_{C}. The block A is preferably prepared by polymerization of monomers comprising potentially anionic monomers A_{A}.

Stages 1) and 2) are sequential. The possibility of carrying out other polymerization stages before stage 3) is not ruled out. It is possible to prepare the block B during stage 1), then a block A during stage 2) and optionally another block B during a subsequent stage. However, it is preferable to prepare the block A during stage 1) and then at least one block B during stage 2). In all cases, it is preferable to carry out stage 2) on a block resulting from stage 1) which does not carry a charge. To this end, if the block B is prepared during stage 2), in particular if the preparation is carried out directly using monomers B_{C} (without subsequent chemical modification), the preparation is preferably carried out at a pH such that the units A_{A} are in the neutral form, preferably in an acid medium, for example at a pH of less than or equal to 4, preferably 3, for example 2. However, if the block A is prepared during stage 2), then it may be preferable to prepare a precursor of the block B during stage 1) which is nonionic or potentially cationic in the neutral form and then to chemically modify it during a stage 3). If the monomer B_{C} is of diallylammonium type, it is preferable to polymerize it during stage 2).

Chemical modifications which can be carried out in the context of stage 3) have been described above: they are, for example, quaternizations, in order to obtain the block B, and hydrolysis, in order to obtain the block A. Preferably, stage 3) of chemical modification is not carried out, monomers B_{C} being directly polymerized during either of stages 1) and 2) and monomers A_{A} being directly polymerized during the other stage.

The process can in particular comprise a stage of deactivation of transfer groups carried by macromolecular chains and/or of purification of the copolymer and/or of destruction of by-products from chemical modification and/or from deactivation. Such a stage can be carried out after the polymerization stages. It can be carried out before or after stage 3), if the latter is employed. During the optional stage of purification and/or deactivation and/or destruction, the block copolymers obtained or the by-products can be subjected to a reaction for purification from or destruction of certain entities, for example by processes of hydrolysis, oxidation, reduction, pyrolysis, ozonolysis or substitution type. A stage of oxidation with aqueous hydrogen peroxide solution is particularly appropriate for treating sulfur-comprising entities. It is mentioned that some of these reactions or operations can take place in all or part during stage 3). In this case, for these reactions or operations, the two stages are simultaneous.

Preferably, for the polymerization stages (stages 1) and 2) in particular), use is made of “living” or “controlled” radical polymerization methods and particularly preferably of controlled or living radical polymerization methods employing a transfer agent comprising a transfer group of formula —S—CS—, known in particular under the names of RAFT or MADIX.

Reference may in particular be made, as examples of “living” or “controlled” polymerization processes, to:
the processes of Applications WO 98/58974, WO 00/75207 and WO 01/42312, which employ a radical polymerization controlled by control agents of xanthate type,
the radical polymerization process controlled by control agents of dithioester or trithiocarbonate type of Application WO 98/01478,
the radical polymerization process controlled by control agents of dithiocarbamate type of Application WO 99/31144,
the radical polymerization process controlled by control agents of dithiocarbazate type of Application WO 02/26836,
the radical polymerization process controlled by control agents of dithiophosphoric ester type of Application WO 02/10223,
the process of Application WO 99/03894, which employs a polymerization in the presence of nitroxide precursors, or processes employing other nitroxides or nitroxide/alkoxyamine complexes,
the process of Application WO 96/30421, which uses an atom transfer radical polymerization (ATRP),
the radical polymerization process controlled by control agents of iniferter type according to the teaching of Otu et al., Makromol. Chem. Rapid. Commun., 3, 127 (1982),
the radical polymerization process controlled by iodine degenerative transfer according to the teaching of Tatemoto et al., Jap. 50, 127, 991 (1975), Daikin Kogyo Co Ltd Japan, and Matyjaszewski et al., Macromolecules, 28, 2093 (1995),
the radical polymerization process controlled by tetraphenylethane derivatives disclosed by D. Braun et al. in Macromol. Symp., 111, 63 (1996), or also
the radical polymerization process controlled by organocobalt complexes described by Wayland et al. in J. Am. Chem. Soc. 116, 7973 (1994),
the radical polymerization process controlled by diphenylethylene (WO 00/39169 or WO 00/37507).

Stages 1) and 2) can typically be carried out by bringing together the monomers, a control agent and optionally at least one source of free radicals. The source of free radicals can be an initiator. Use is preferably made of such an initiator during stage 1). An initiator can again be introduced during stage 2). It is also possible to use free radicals present in the reaction medium resulting from stage 1).

The polymerizations can be carried out in the presence of free radical initiators known to a person skilled in the art. Use may be made, for example, of sodium persulfate. Use may typically be made of amounts of initiators of 5 to 50% by number, with respect to the amount of transfer agent.

The polymerizations are advantageously carried out in solution, preferably in an aqueous, alcoholic or aqueous/alcoholic medium.

Transfer agents of use in the implementation of the process (during stages 1) and 2)) are known to a person skilled in the art and include in particular compounds comprising a transfer group —S—CS—, for the implementation of polymerization processes known under the terms of RAFT and/or MADIX. Use is preferably made of a transfer agent comprising a transfer group of formula —S—CS—O— (xanthate). Such processes and agents are described in detail below.

During the polymerization stages, it is possible to prepare a first block from monomers or a mixture of monomers, initiators and/or agents which promote the control of the polymerization (transfer agents comprising groups of the type —S—CS—, nitroxides, and the like) and then to grow a second block on the first block in order to obtain a diblock copolymer with different compositions formed of monomers from those used for the preparation of the preceding block (in particular with different monomers) and optionally with addition of initiators and/or agents which promote the control of the polymerization. These processes for the preparation of block copolymers are known to a person skilled in the art. It is mentioned that the copolymer can exhibit, at the chain end or at the center of the chains, a transfer group or residue of a transfer group, for example a group comprising an —S—CS— group (for example resulting from a xanthate, from a dithioester, from a dithiocarbamate or from a trithiocarbonate) or a residue of such a group.

It is mentioned that it would not be departing from the scope of the invention to employ and to adapt preparation processes resulting in triblock copolymers, if appropriate subsequently modified (for example during a specific stage or during a stage of destruction and/or deactivation and/or purification) so as to obtain diblock copolymers. In particular, it is possible to envisage employing transfer agents comprising several transfer groups (for example trithiocarbonates Z—S—CS—S—Z), resulting in telechelic copolymers of R-[(block B)-(block A)]_{w}, type, such as triblocks of (core)-[(block A)-(block B)]ₓ type (for example (block A)-(block B)-R-(block B)-(block A), such as triblocks (block A)-(block B)-(core)-(block B)-(block A)), and then breaking the telechelic copolymers at the core (splitting, “cleaving”), in order to obtain diblock copolymers (block A)-(block B). Splitting can take place during a hydrolysis. In such cases, a person skilled in the art will adjust the processing conditions in order to target average molecular weights equivalent to those indicated, for example by multiplying the amounts of monomers introduced by the number of transfer groups included in the transfer agent.

### Uses

The copolymers can in particular be used in compositions, for example aqueous compositions, comprising a product dispersed or dissolved in the composition. The product is typically a product other than the copolymer, the latter preferably being an additive. The copolymer can in particular be used, preferably in aqueous compositions, to stabilize a dispersed product and/or to control the stabilization or destabilization of a product under the impact of a change applied to the composition, such as the addition of a compound, diluting and/or a change in pH, or such as a change in temperature. It can be used as agent for the controlled release of active principles.

Mention is made in particular, as aqueous compositions where the copolymer can be used, of:
plant-protection compositions,
inks,
pigment compositions,
cosmetic compositions, in particular compositions intended to be rinsed off or compositions intended to be left on the skin, for example sun protection products,
water treatment compositions,
household care compositions, for example detergents or compositions for cleaning hard surfaces or compositions for cleaning or rinsing laundry or compositions for cleaning or rinsing dishes, in a machine or by hand,
compositions for the treatment of plastics,
coating compositions, or compositions for pretreatment before coating,
fluid compositions employed in the exploitation of oil and/or gas fields,
aqueous lubricants,
pharmaceutical compositions.

Other details or advantages of the invention may become apparent in the light of the examples which follow, without a limiting nature.

### EXAMPLES

The relative molar masses of the neutral or anionic hydrophilic polymers (e.g.: poly(acrylic acid) and poly(acrylamide) homopolymers) are characterized by steric exclusion chromatography (SEC) using a Shodex OH pak SB-G precolumn, (No. L410061) and three Shodex columns of 30 cm OH pak SB-806M HQ (Nos. L 411 054; L 411 055; L 411 056) and a mobile phase comprising acetonitrile in a solution of deionized water additivated with 0.1 mol/l of NaNO₃, the acetonitrile/water ratio by volume being 20/80. The relative molar masses of the copolymers comprising a cationic block are characterized by steric exclusion chromatography (SEC) using a Shodex OH pak SB-G precolumn, (No. L 211067) and three Shodex columns of 30 cm OH pak SB-806M HQ (Nos. L 301011; L 301013; L 301014) and a mobile phase comprising acetonitrile in a solution of deionized water additivated with 1 mol/l of NH₄NO₃ and 100 ppm of DADMAC (so as to passivate the columns), the acetonitrile/water ratio by volume being 20/80. All the measurements of the relative molar masses are made with respect to poly(ethylene oxide) standards.

In the examples, the water used is deionized water.

### Example 1

### Synthesis of a Poly(Acrylic Acid) [500]-Block-Poly(Diallyldimethylammonium Chloride) [3000] Diblock Copolymer

The values in square brackets correspond to the theoretical average molar masses for each block.

### Example 1.1

### Synthesis of the Poly(Acrylic Acid) Block

31.87 g of O-ethyl S-(1-(methoxycarbonyl)ethyl)xanthate (CH₃CHCO₂CH₃)S(C═S)OEt, 101.3 g of ethanol, 8.5 g of acrylic acid and 23.64 g of deionized water are introduced at ambient temperature into a 2 l jacketed glass reactor equipped with a mechanical stirrer and a reflux condenser. The temperature of the solution is increased up to 70° C. As soon as this temperature has been reached, 0.49 g of 4,4′-azobis(cyanovaleric acid) is introduced. Starting with the introduction of this initiator, a solution of 76.5 g of acrylic acid in 212.8 g of water is introduced over one hour. At the end of the introduction, 0.49 g of 4,4′-azobis(cyanovaleric acid) is again introduced. The reaction is prolonged for three hours after the end of the introduction.

A sample of polymer is withdrawn. The analysis of the product by high performance liquid chromatography (HPLC) allows it to be concluded that all the acrylic acid has reacted during the polymerization. A steric exclusion chromatography (SEC) analysis with relative calibration with poly(ethylene oxide) provides the following number-average molar mass (Mₙ) and polydispersity index (M_{w}/Mₙ) values: Mₙ=650 g/mol, M_{w}/Mₙ=1.60.

### Example 1.2

### Preparation of the Diblock Copolymer

At the end of the synthesis of the first block, as described in Example 1.1, the temperature is reduced down to 65° C. Once this temperature has stabilized, a solution of 706 g of diallyldimethylammonium chloride (DADMAC) at 65% by weight in water, and also 4 g of V50 initiator sold by Wako (2,2′-azobis(2-methylpropionamidine) dihydrochloride), are introduced. The reaction is subsequently maintained at this temperature for twelve hours. After reacting for 4 hours and 8 hours, 4 g of V50 initiator are added on each occasion to the reaction medium. At the end of the reaction, a sample is withdrawn. A ¹H NMR analysis gives a DADMAC conversion of 98.2%. Mₙ and M_{w}/Mₙ are measured by SEC in water with a poly(ethylene oxide) calibration curve: Mₙ=2500; M_{w}/Mₙ=1.50. The superimposition of the two chromatograms of the products from Example 1.1 and from Example 1.2 allows it to be concluded that the copolymer formed is diblock in nature. This is because the SEC chromatogram of the product from Example 1.1 is completely shifted towards the range of the higher molecular weights at the end of the synthesis of the product from Example 1.2.

The diblock copolymer is soluble in water (in particular at 2% by weight). It makes it possible to stabilize (with an amount of 1% by weight) a colloidal inorganic suspension over a pH range extending from 3 to 10. By way of comparison, the same colloidal suspension is unstable (flocculation) at a pH of greater than 3 in the absence of the copolymer or in the presence of a diblock copolymer of neutral-block-cationic type comprising a block deriving from acrylamide with a theoretical molar mass of 500 g/mol and a block deriving from APTAC with a theoretical molar mass of 3000 g/mol.

### Example 2

### Synthesis of a Poly(Acrylic Acid) [1000]-Block-Poly(3-acrylamidopropyltrimethylammonium “APTAC”) [3000] Diblock Copolymer

The values in square brackets correspond to the theoretical average molar masses for each block.

### Example 2.1

### Synthesis of the Poly(Acrylic Acid) Block

6.2 g of O-ethyl S-(1-(methoxycarbonyl)ethyl) xanthate (CH₃CHCO₂CH₃)S(C═S)OEt, 23.7 g of ethanol, 30 g of acrylic acid and 74.9 g of deionized water are introduced at ambient temperature into a 250 ml jacketed glass reactor equipped with a magnetic stirrer and a reflux condenser, and subjected to a stream of nitrogen for 5 min. The temperature of the solution is increased up to 70° C. As soon as this temperature has been reached, 0.167 g of 4,4′-azobis(cyanovaleric acid) is introduced. After refluxing for three hours, 0.167 g of 4,4′-azobis(cyanovaleric acid) is again introduced. The reaction is prolonged for a further four hours with magnetic stirring.

A sample of polymer is withdrawn. The analysis of the product by high performance liquid chromatography (HPLC) allows it to be concluded that all the acrylic acid has reacted during the polymerization. A steric exclusion chromatography (SEC) analysis with relative poly(ethylene oxide) calibration provides the following number-average molar mass (Mₙ) and polydispersity index (M_{w}/Mₙ) values: Mₙ=960 g/mol, M_{w}/Mₙ=1.70.

### Example 2.2

### Preparation of the Diblock Copolymer

At the end of the synthesis of the first block, as described in Example 2.1, the temperature is reduced down to 65° C. Once this temperature has stabilized, a solution of 15.7 g of 3-acrylamidopropyltrimethylammonium chloride (APTAC) at 75% by weight in water, 0.073 g of V50 initiator (2,2′-azobis(2-methylpropionamidine) dihydrochloride) and 10 g of deionized water, degassed beforehand with a stream of nitrogen (5 min), are introduced into the solution of the first block. The reaction is subsequently maintained at this temperature (65° C.) for 9 h 30 with magnetic stirring. After reacting for 4 hours, a further 0.073 g of V50 initiator is added to the reaction medium. At the end of the reaction, a sample is withdrawn. A ¹H NMR analysis gives an APTAC conversion of 99%. Mₙ and M_{w}/Mₙ are measured by SEC, after calibrating with poly(ethylene oxide), giving: Mₙ=2740 g/mol; M_{W}/Mₙ=1.50. The superimposition of the two chromatograms of the products from Example 2.1 and from Example 2.2 allows it to be concluded that the copolymer formed is of diblock nature. This is because the SEC chromatogram of the product from Example 3 is completely shifted towards the range of the higher molecular weights at the end of the synthesis of the product from Example 2.2.

The diblock copolymer is soluble in water (in particular at 2% by weight).

It makes it possible to stabilize (with an amount of 1% by weight) a colloidal inorganic suspension over a pH range extending from 3 to 10. By way of comparison, the same colloidal suspension is unstable (flocculation) at a pH of greater than 3 in the absence of the copolymer or in the presence of a diblock copolymer of neutral-block-cationic type comprising a block deriving from acrylamide with a theoretical molar mass of 500 g/mol and a block deriving from APTAC with a theoretical molar mass of 3000 g/mol.

1-26. (canceled)

27. An ampholytic copolymer comprising at least one macromolecular chain B and at least one part A bonded to one end of the macromolecular chain B, wherein:
the macromolecular chain B comprises cationic units B_{C} deriving from cationic monomers B_{C}.
the part A is a macromolecular chain A comprising potentially anionic units A_{A} deriving from potentially anionic monomers A_{A},
wherein:
the units B_{C} comprise a quaternary ammonium group, and
the units A_{A} comprise a group comprising, in the acid or salified form:
a carboxylate group —COO⁻
a sulfonate group —SO₃⁻
a sulfate group —SO₄⁻
a phosphonate group —PO₃²⁻, or
a phosphate group —PO₄²⁻,
further wherein the units A_{A} are not units deriving from styrenesulfonate in the acid or salified form.

28. The copolymer of claim 27, wherein the net charge of the copolymer is positive at a pH of greater than or equal to 4.5.

29. The copolymer of claim 27, wherein said copolymer comprises a greater number of B_{C} units than A_{A} units.

30. The copolymer of claim 27, wherein the copolymer is a block copolymer comprising at least one block A and at least one block B,
wherein the macromolecular chain A comprises the block A and the macromolecular chain B comprises the block B.

31. The copolymer of claim 27, wherein the copolymer comprises:
a (block A)-(block B) diblock copolymer, wherein the part A comprises the block A, and the macromolecular chain B comprises the block B,
a (block B)-(block A)-(block B) triblock copolymer, wherein the part A comprises the block A, and the macromolecular chain B comprises the block B, or
a (block A)-(block B)-(block A) triblock copolymer.

32. The copolymer of claim 31, wherein the copolymer is a linear diblock or triblock copolymer, wherein the block A and the block B derive from ethylenically unsaturated monomers.

33. The copolymer of claim 27, wherein the units B_{C} are cationic units comprising units deriving from cationic monomers comprising:
trimethylammoniopropyl methacrylate chloride,
trimethylammonioethylacrylamide or -methacrylamide chloride or bromide;
trimethylammoniobutylacrylamide or -methylacrylamide methyl sulfate;
trimethylammoniopropylmethacrylamide methyl sulfate (MAPTA MeS);
(3-methacrylamidopropyl)trimethylammonium chloride (MAPTAC);
(3-acrylamidopropyl)trimethylammonium chloride (APTAC);
methacryloyloxyethyltrimethylammonium chloride or methyl sulfate;
acryloyloxyethyltrimethylammonium salts (ADAMQUAT);
1-ethyl-2-vinylpyridinium or 1-ethyl-4-vinylpyridinium bromide, chloride or methyl sulfate;
N,N-dimethyldiallylammonium chloride (DADMAC);
dimethylaminopropylmethacrylamide, N-(3-chloro-2-hydroxypropyl)trimethylammonium chloride (DIQUAT);
a monomer of formula: 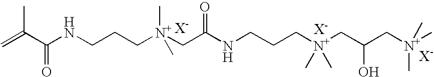
wherein X⁻ is an anion, or
mixtures or combinations thereof.

34. The copolymer of claim 27, wherein the units A_{A} are potentially anionic units comprising units deriving from potentially anionic monomers A_{A} comprising:
acrylic acid, acrylic anhydride, methacrylic acid, methacrylic anhydride, maleic acid, maleic anhydride, fumaric acid, itaconic acid, N-methacryloylalanine, N-acryloylglycine, or their water-soluble salts, or
vinylphosphonic acid or ethylenically unsaturated phosphate esters.

35. The copolymer of claim 27, wherein the macromolecular chain B comprises units Bₒₜₕₑᵣ, wherein units Bₒₜₕₑᵣ are different than units B_{C}, and derive from at least one monomer Bₒₜₕₑᵣ.

36. The copolymer of claim 35, wherein the macromolecular chain B comprises the units B_{C} in an amount ranging from 1 to 100% by weight.

37. The copolymer of claim 27, wherein the macromolecular chain A comprises units Aₒₜₕₑᵣ, which are different than the units A_{A}, and which derive from at least one monomer Aₒₜₕₑᵣ.

38. The copolymer of claim 37, wherein the macromolecular chain A comprises units A_{A} in an amount ranging from 1 to 100% by weight.

39. The copolymer of claim 27, wherein the ratio by weight of the macromolecular chain A to the part B is greater than 1.

40. The copolymer of claim 27, wherein said copolymer has a theoretical average molar mass ranging from 500 to 50 000 g/mol.

41. The copolymer of claim 27, wherein the macromolecular chains A and B are bonded to one another via a carbon-carbon bond.

42. A process for the preparation of a block copolymer comprising at least one block B and at least one block A,
wherein:
the block B comprises cationic units B_{C} deriving from cationic monomers B_{C},
the block A comprises potentially anionic units A_{A} deriving from potentially anionic monomers A_{A},
further wherein:
the units B_{C} comprise a quaternary ammonium group, and
the units A_{A} comprise a group comprising, in the acid or salified form:
a carboxylate group —COO⁻
a sulfonate group —SO₃⁻
a sulfate group —SO₄⁻
a phosphonate group —PO₃²⁻, or
a phosphate group —PO₄²⁻,
further wherein the units A_{A} are not units deriving from styrenesulfonate in the acid or salified form.
said process comprising the steps of:
i) polymerizing monomers to obtain a first block comprising the block A, the block B, or a precursor block of the first block,
ii) polymerizing monomers to obtain at least one second block comprising:
the block A, if a block B or a precursor was obtained in step i),
the block B, if a block A or a precursor was obtained in step i), or
a precursor block of the second block,
iii) optionally chemically modifying said precursor blocks obtained in steps i) and/or ii) to obtain the block A and/or the block B.

43. The process of claim 42, wherein the polymerizations of steps i) and step ii) are carried out by bringing together the monomers, a control agent, and at least one source of free radicals.

44. The process of claim 43, wherein the control agent comprises a group of formula —S—CS—.

45. The process of claim 42, wherein the block A is prepared in step ii) and the block B is prepared in step ii).

46. The process of claim 42, wherein the polymerizations are carried out in solution.

47. The process of claim 42, wherein, if the block B is prepared during step ii), then step ii) is carried out under pH conditions such that the units A_{A} are in the neutral form.

48. The process of claim 42, wherein the block B is prepared by polymerization of monomers comprising cationic monomers B_{C}.

49. The process of claim 42, wherein the block A is prepared by polymerization of Monomers comprising potentially anionic monomers A_{A}.

50. The process of claim 42, wherein said process does not comprise step iii).

51. A method of stabilizing a dispersed product and/or controlling the stabilization or destabilization of a product under the impact of a change applied to said product, comprising:
contacting said product with the composition of claim 27;
wherein said change includes:
an addition of a compound,
a dilution
a change in pH,
a change in temperature, or
a combination thereof.
